(19) United States
(12) Patent Application Publication
(10) Pub. No.: US 2019/0204639 A1
(43) Pub. Date: Jul. 4, 2019

(54) DISPLAY PANEL AND DISPLAY DEVICE

(71) Applicants: HKC Corporation Limited, SHENZHEN (CN); Chongqing HKC Optoelectronics Technology Co., Ltd., CHONGQING (CN)

(72) Inventor: QIONG WU, CHONGQING (CN)

(21) Appl. No.: 16/311,664

(22) PCT Filed: Oct. 16, 2017
(86) PCT No.: PCT/CN2017/106310

§ 371 Date: Dec. 19, 2018

(30) Foreign Application Priority Data
Dec. 29, 2016 (CN) 201611254561.X

(51) Int. Cl. G02F 1/1339; G02F 1/1335

(52) U.S. Cl. CPC G02F 1/1339; G02F 1/133528; G02F 2001/133334; G02F 1/133512; G02F 1/133514

(57) ABSTRACT

The present application discloses a display panel and a display device. The display panel includes a first substrate including an active switch array and a surrounding metal circuit disposed around the active switch array; a second substrate disposed opposite to the first substrate; a liquid crystal layer formed between the first substrate and the second substrate; a front polarizer disposed on the outer side of the first substrate; a rear polarizer disposed on the outer side of the color filter substrate; a sealing layer formed around the display panel and configured to seal the liquid crystal layer between the first substrate and the second substrate; and a light shielding protective adhesive layer formed on the sealing layer.

### TECHNICAL FIELD

The present application relates to the technical field of display screens, and in particular, to a display panel and a display device.

### BACKGROUND

A liquid crystal display (LCD) has gradually occupied a dominant position in the display field due to its low power consumption, excellent picture quality and high production yield and the like. Similarly, the liquid crystal display includes a liquid crystal panel and a backlight module, where the liquid crystal panel includes a color filter (CF) substrate and a thin film transistor (TFT) substrate. Transparent electrodes are disposed on the opposite inner sides of the aforementioned substrates. A layer of liquid crystal (LC) molecules is sandwiched between the two substrates.

In order to highlight the integration of the real picture by a liquid crystal display, a frameless design came into being. After the frame is omitted, the problem of side light leakage occurring to the edge must be solved. Otherwise, there will be a phenomenon of peripheral light leakage. Some people tried to use a black adhesive tape for adhesion to solve the side light leakage problem. However, after the long-term use of the black adhesive tape, problems such as falling off may occur, which brings about many problems.

### SUMMARY

In view of the above drawbacks of the prior art, against the technical problem to be solved, the present application provides a display panel and a display device which can improve yield and prevent light leakage.

To achieve the above objective, the present application provides a display panel, which includes:

a first substrate, which includes an active switch array and a surrounding metal circuit, where the surrounding metal circuit is disposed around the active switch array;

a second substrate disposed opposite to the first substrate;

a liquid crystal layer formed between the first substrate and the second substrate;

a front polarizer disposed on the outer side of the first substrate;

a rear polarizer disposed on the outer side of a color filter substrate;

sealing layers formed around the display panel and configured to seal the liquid crystal layer between the first substrate and the second substrate; and

a light shielding protective adhesive layer formed on the sealing layer, where the light shielding protective adhesive layer extends from the edge of the rear polarizer to the outer side of the front polarizer and shields the surrounding metal circuit.

In some embodiments, the sealing layer includes a light shielding layer which adopts light shielding ink.

In some embodiments, the sealing layer includes a sealing adhesive layer which adopts a hot melt adhesive.

In some embodiments, the sealing layer includes a sealing adhesive layer which adopts a photocurable adhesive.

In some embodiments, the light shielding protective adhesive layer includes an electromagnetic wave protective adhesive layer, a water vapor protective adhesive layer or an electromagnetic water vapor protective adhesive layer.

In some embodiments, the light shielding layer adopts light shielding ink; the sealing adhesive layer adopts a hot melt adhesive or a photocurable adhesive.

In some embodiments, the light shielding layer adopts a black sealant or a black adhesive tape, and the sealing adhesive layer adopts a hot melt adhesive or a curable adhesive.

The present application also provides a display device including the display panel as described above.

The present application also provides a display panel, which includes:

a first substrate, which includes an active switch array and a surrounding metal circuit, where the surrounding metal circuit is disposed around the active switch array;

a second substrate disposed opposite to the first substrate;

a liquid crystal layer formed between the first substrate and the second substrate;

a front polarizer disposed on the outer side of the first substrate;

a rear polarizer disposed on the outer side of a color filter substrate;

sealing layers formed around the display panel and configured to seal the liquid crystal layer between the first substrate and the second substrate; and

a light shielding protective adhesive layer formed on the sealing layer, where the light shielding protective adhesive layer extends from the edge of the rear polarizer to the outer side of the front polarizer and shields the surrounding metal circuit.

The sealing layer includes a light shielding layer and a sealing adhesive layer, where the light shielding layer adopts light shielding ink, and the sealing adhesive layer adopts a hot melt adhesive;

The light shielding protective adhesive layer includes an electromagnetic wave protective adhesive layer, a water vapor protective adhesive layer or an electromagnetic water vapor protective adhesive layer.

Further, the light shielding layer adopts light shielding ink. The light shielding ink may be black light shielding ink, and the goal of better preventing the light from passing is achieved by the combination of light shielding and light absorption; besides, in this solution, the requirements for physical properties of the material are not high, not only does the light shielding ink not need to have sufficient viscosity, but also as for the shading rate, the shading rate of the light shielding ink may be about 90%.

Further, the sealing adhesive layer adopts a hot melt adhesive. The hot melt adhesive is polyurethane reactive (PUR) hot melt adhesive. Its mechanism of action is that polyurethane prepolymer reacts with moisture in the air and is cured and cross-linked to form a stable chemical structure; the PUR hot melt adhesive has good weather resistance: due to the irreversible characteristics after bridging, the PUR hot melt adhesive will not be subjected to creep and embrittlement caused by changes in ambient temperature; moreover, the PUR hot melt adhesive has high toughness, high initial adhesion and very high permeability and affinity, and its bond strength is 40% to 60% higher than that of other adhesives under the same conditions, which reduces the amount of the adhesive used; the yield of the product of the present application is ensured, and the problems such as falling off are solved.

Further, the sealing adhesive layer adopts a photocurable adhesive. The photocurable adhesive, namely ultraviolet-curable adhesive (UV-curable adhesive), is an adhesive that must be cured by ultraviolet light. Its curing principle is that a photoinitiator (or photosensitizer) in a UV-curable material absorbs ultraviolet light under irradiation of ultraviolet light and produces active radicals or cations, which initiates monomer polymerization and cross-linked chemical reaction, so that the adhesive is converted from a liquid to a solid in a few seconds, thereby greatly improving the working efficiency; besides, after curing, the adhesive is completely transparent, and the product is not yellow for a long time, and is not whitened. Compared with a conventional instantaneous adhesive for bonding, the photocurable adhesive has the advantages of environmental monitoring endurance, no whitening and good flexibility, etc.; its viscosity and durability are far higher than those of sealing materials such as a black adhesive tape, thereby solving the problem of falling off and greatly improving the yield of the product.

Further, the first substrate includes an array substrate; the second substrate includes a color filter substrate;

the display panel further includes a front polarizer disposed on the outer side of the array substrate and a rear polarizer disposed on the outer side of the color filter substrate;

The sealing layer includes a light shielding layer disposed on the inner side, a sealing adhesive layer disposed at the middle, and a protective adhesive layer disposed on the outer side of the sealing adhesive layer and configured to seal the edges of the front polarizer and the rear polarizer. In this solution, since a protective adhesive layer is disposed on the periphery of the sealing layer, the dust resistance, water resistance, electromagnetic wave resistance and impact resistance and the like of the substrate are improved; moreover, because the protective adhesive layer is adopted for sealing from the edges of the front polarizer and the rear polarizer, the front polarizer and the rear polarizer are also protected from impact and the like, the problem of poor upwarp of the polarizer can be solved, and the yield of the product is improved; the three-layer structure of combination of the light shielding layer, the sealing adhesive layer and the protective adhesive layer has better light shielding, sealing and cushioning effects than a single-layer composite adhesive; moreover, the requirements a single layer intangible material are lowered, and the technical requirements are lowered while the yield of the product is improved.

Further, the first substrate includes an array substrate; the second substrate includes a color filter substrate;

the display panel further includes a front polarizer disposed on the outer side of the array substrate and a rear polarizer disposed on the outer side of the color filter substrate;

The sealing layer includes a sealing adhesive layer disposed on the inner side, a light shielding layer disposed at the middle, and a protective adhesive layer disposed on the outer side of the light shielding layer and configured to seal the edges of the front polarizer and the rear polarizer. In this solution, since a protective adhesive layer is disposed on the periphery of the sealing layer, the dust resistance, water resistance, electromagnetic wave resistance and impact resistance and the like of the substrate are improved; moreover, because the protective adhesive layer is adopted for sealing from the edges of the front polarizer and the rear polarizer, the front polarizer and the rear polarizer are also protected from impact and the like, the problem of poor upwarp of the polarizer can be solved, and the yield of the product is improved; the three-layer structure of combination of the light shielding layer, the sealing adhesive layer and the protective adhesive layer has better light shielding, sealing and cushioning effects than a single-layer composite adhesive; moreover, the requirements a single layer intangible material are lowered, and the technical requirements are lowered while the yield of the product is improved.

Further, the protective adhesive layer includes an electromagnetic wave protective adhesive layer, a water vapor protective adhesive layer or an electromagnetic water vapor protective adhesive layer. In this solution, the electromagnetic wave protective adhesive layer, the water vapor protective adhesive layer or the electromagnetic water vapor protective adhesive layer can be selected according to different product positioning and different requirements, thereby achieving effects such as water vapor protection or static electricity protection, and improving product quality.

Further, the light shielding layer adopts light shielding ink; the sealing adhesive layer adopts a hot melt adhesive or a photocurable adhesive;

the first substrate includes an array substrate; the second substrate includes a color filter substrate;

the display panel further includes a front polarizer disposed on the outer side of the array substrate and a rear polarizer disposed on the outer side of the color filter substrate;

the sealing layer includes a light shielding layer disposed on the inner side, a sealing adhesive layer disposed at the middle, and a protective adhesive layer disposed on the outer side of the sealing adhesive layer and configured to seal the edges of the front polarizer and the rear polarizer;

the protective adhesive layer includes an electromagnetic wave protective adhesive, a water vapor protective adhesive or an electromagnetic water vapor protective adhesive. The three-layer structure of combination of the light shielding layer, the sealing adhesive layer and the protective adhesive layer has better light shielding, sealing and cushioning effects than a single-layer composite adhesive; moreover, the requirements a single layer intangible material are lowered, and the technical requirements are lowered while the yield of the product is improved.

Further, the light shielding layer adopts a black sealant or a black adhesive tape, and the sealing adhesive layer adopts a hot melt adhesive or a curable adhesive;

the first substrate includes an array substrate; the second substrate includes a color filter substrate;

the display panel further includes a front polarizer disposed on the outer side of the array substrate and a rear polarizer disposed on the outer side of the color filter substrate;

the sealing layer also includes a protective adhesive layer disposed on the outer side of the sealing adhesive layer and configured to seal the edges of the front polarizer and the rear polarizer;

the protective adhesive layer includes an electromagnetic wave protective adhesive, a water vapor protective adhesive or an electromagnetic water vapor protective adhesive. In this solution, the black adhesive tape or the black sealant is retained, so that original related apparatuses can be retained to prevent waste, and the sealing adhesive layer and the protective adhesive layer are disposed on the outer side of the black adhesive tape or the black sealant, thereby improving the light shielding, viscosity, durability, impact resistance, water vapor resistance, anti-static performance and the like of the product in this solution can be improved; moreover, the physical property requirements for the black adhesive tape or black sealant are also relatively reduced, i.e., the original unqualified black adhesive tape or black sealant already can be used partially to reduce waste and improve product yield.

A display device includes any disclosed display panel of the present application.

The present application has the beneficial effects that a frameless display panel, such as a frameless liquid crystal panel, mainly includes a substrate and a backlight module, where the substrate mainly includes an array substrate, a color filter substrate, and a sealing layer for sealing the array substrate and the color filter substrate from the two ends. An existing sealing layer is used for sealing often by the adoption of the black adhesive tape, but after long-term use, the black adhesive tape is prone to viscosity weakening and falling off, which will lead to the problems of light leakage and low product yield. In the present application, since the light shielding layer and the sealing adhesive layer are used and functions of each layer are clear, it is not necessary to consider the shading rate and the sealing property as in the black adhesive tape, so that the specificity can be achieved, thereby achieving better shading and sealing performance, solving the problems of falling off and light leakage, and enhancing the product yield.

Specific embodiments of the present application are disclosed in detail with reference to the following description and accompanying drawings, and the manner in which the principles of the present application can be employed is indicated. It should be understood that the embodiments of the present application are not limited in scope. The embodiments of the present application include many variations, modifications, and equivalents within the scope of the spirit and scope of the appended claims.

Features described and/or illustrated with respect to one embodiment may be used in the same or similar manner in one or more other embodiments, and the features may be combined with features in other embodiments, or replace features in other embodiments.

It should be emphasized that the term “comprise/include”, when used herein, refers to the presence of a feature, assembly, step or component, but does not exclude the presence or addition of one or more other features, assemblies, steps or components.

### BRIEF DESCRIPTION OF DRAWINGS

The drawings are included to provide further understanding of embodiments of the present application, which constitute a part of the specification and illustrate the embodiments of the present application, and describe the principles of the present application together with the text description. Apparently, the accompanying drawings in the following description show merely some embodiments of the present application, and a person of ordinary skill in the art may still derive other accompanying drawings from these accompanying drawings without creative efforts. In the accompanying drawings:

FIG. 1 is a schematic view of a display panel using a black sealant as a sealing layer;

FIG. 2 is a schematic view of a display panel of the present application;

FIG. 3 is a second schematic view of a display panel of the present application;

FIG. 4 is a third schematic view of a display panel of the present application;

FIG. 5 is a schematic view of a display device of the present application; and

FIG. 6 is a schematic view of a display panel of the present application.

### DETAILED DESCRIPTION

In order to enable a person skilled in the art to better understand the technical solutions in the present application, the technical solutions in the embodiments of the present application are clearly and completely described in the following with reference to the accompanying drawings in the embodiments of the present application. Apparently, the described embodiments are merely some embodiments of the present application rather than all embodiments. All other embodiments obtained by a person of ordinary skill in the art based on the embodiments of the present application without creative efforts should be within the protective scope of the present application.

In order to highlight the integration of the real picture by a frameless product which is a thin film transistor-liquid crystal display (TFT-LCD), a frameless design came into being. After the frame is omitted, the problem of side light leakage occurring to the edge must be solved. Otherwise, there will be a phenomenon of peripheral light leakage. Some people tried to use the black adhesive tape for adhesion to solve the side light leakage problem. However, after the long-term use of the black adhesive tape, problems such as falling off may occur, which brings about many problems.

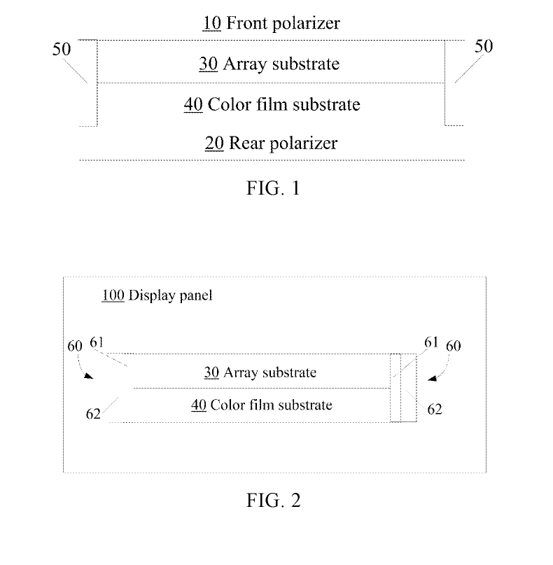

FIG. 1 is a schematic view of a display panel using a black sealant as a sealing layer. As shown in FIG. 1, in order to solve the problem of black adhesive tape falling off, the inventor ever used a black sealant 50 instead of the black adhesive tape, i.e., the two ends of an array substrate 30 and a color filter substrate 40 are coated with the black sealant 50, to absorb light and prevent the light from passing, which largely achieves the shielding effect of the original black adhesive tape, and at the same time, reduces problem of falling off after long-term use.

However, this method needs an increase in material and process, which is not only troublesome but also costly; moreover, because of the high physical property requirements for the black sealant, not only is it required to have a light shielding property, but also sufficient viscosity, water resistance, and even impact resistance and the like are required. This further increases the difficulty of promotion of this method.

In order to solve these problems, the following solution is obtained through the further improvement by the inventor:

FIG. 2 is a schematic view of a display panel of the present application. Referring to the embodiment shown by FIG. 1, the display panel 100 includes:

a first substrate (e.g., an array substrate 30);

a second substrate (e.g., a color filter substrate 40) which is disposed opposite to the first substrate; and

sealing layers 60 disposed at the two ends of the display panel 100 and configured to seal the first substrate and the second substrate;

the sealing layer 60 includes:

a light shielding layer 61 and a sealing adhesive layer 62.

The positions of the light shielding layer 61 and the sealing adhesive layer 62 shown in the accompanying drawing may be interchanged.

In some embodiments, a TFT array and a color filter can also be formed on a single substrate.

In some embodiments, the display panel 100 can be, for example, a liquid crystal display panel, an organic light-emitting diode (OLED) display panel, a curved display panel, or other display panels.

The present application has the beneficial effects that a frameless display panel, such as a frameless liquid crystal panel, mainly includes a substrate and a backlight module, where the substrate mainly includes an array substrate, a color filter substrate, and a sealing layer for sealing the array substrate and the color filter substrate from the two ends. An existing sealing layer is used for sealing often by the adoption of the black adhesive tape, but after long-term use, the black adhesive tape is prone to viscosity weakening and falling off, which will lead to the problems of light leakage and low product yield. In the present application, since the light shielding layer and the sealing adhesive layer are used and functions of each layer are clear, it is not necessary to consider the shading rate and the sealing property as in the black adhesive tape, so that the specificity can be achieved, thereby achieving better shading and sealing performance, solving the problems of falling off and light leakage, and enhancing the product yield.

Preferably, in this embodiment, the light shielding layer 61 adopts light shielding ink. The light shielding ink may be black light shielding ink, and the goal of better preventing the light from passing is achieved by the combination of light shielding and light absorption; besides, in this solution, the requirements for physical properties of the material are not high, not only does the light shielding ink not need to have sufficient viscosity, but also as for the shading rate, the shading rate of the light shielding ink may be about 90%.

Preferably, in this embodiment, the sealing adhesive layer 62 adopts a hot melt adhesive. The hot melt adhesive is polyurethane reactive (PUR) hot melt adhesive. Its mechanism of action is that polyurethane prepolymer reacts with moisture in the air and is cured and cross-linked to form a stable chemical structure; the PUR hot melt adhesive has good weather resistance: due to the irreversible characteristics after bridging, the PUR hot melt adhesive will not be subjected to creep and embrittlement caused by changes in ambient temperature; moreover, the PUR hot melt adhesive has high toughness, high initial adhesion and very high permeability and affinity, and its bond strength is 40% to 60% higher than that of other adhesives under the same conditions, which reduces the amount of the adhesive used; the yield of the product of the present application is ensured, and the problems such as falling off are solved.

Preferably, in this embodiment, the sealing adhesive layer 62 adopts a photocurable adhesive. The photocurable adhesive, namely ultraviolet-curable adhesive (UV-curable adhesive), is an adhesive that must be cured by ultraviolet light. Its curing principle is that a photoinitiator (or photosensitizer) in a UV-curable material absorbs ultraviolet light under irradiation of ultraviolet light and produces active radicals or cations, which initiates monomer polymerization and cross-linked chemical reaction, so that the adhesive is converted from a liquid to a solid in a few seconds, thereby greatly improving the working efficiency; besides, after curing, the adhesive is completely transparent, and the product is not yellow for a long time, and is not whitened. Compared with a conventional instantaneous adhesive for bonding, the photocurable adhesive has the advantages of environmental monitoring endurance, no whitening and good flexibility, etc.; its viscosity and durability are far higher than those of sealing materials such as a black adhesive tape, thereby solving the problem of falling off and greatly improving the yield of the product.

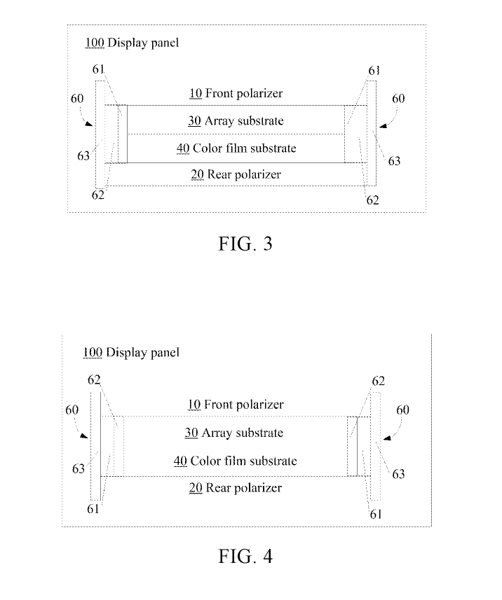

FIG. 3 is a schematic view of a display panel of the present application. Referring to the embodiment shown by FIG. 3, in this embodiment, preferably, the first substrate is, for example, an array substrate 30; the second substrate is, for example, a color filter substrate 40;

the display panel 100 further includes a front polarizer 10 disposed on the outer side of the array substrate 30 and a rear polarizer 20 disposed on the outer side of the color filter substrate 40;

the sealing layer 60 includes a light shielding layer 61 disposed on the inner side, a sealing adhesive layer 62 disposed at the middle, and a protective adhesive layer 63 disposed on the outer side of the sealing adhesive layer 62 and configured to seal the edges of the front polarizer 10 and the rear polarizer 20; In this solution, since a protective adhesive layer is disposed on the periphery of the sealing layer, the dust resistance, water resistance, electromagnetic wave resistance and impact resistance and the like of the substrate are improved; moreover, because the protective adhesive layer is adopted for sealing from the edges of the front polarizer and the rear polarizer, the front polarizer and the rear polarizer are also protected from impact and the like, the problem of poor upwarp of the polarizer can be solved, and the yield of the product is improved; the three-layer structure of combination of the light shielding layer, the sealing adhesive layer and the protective adhesive layer has better light shielding, sealing and cushioning effects than a single-layer composite adhesive; moreover, the requirements a single layer intangible material are lowered, and the technical requirements are lowered while the yield of the product is improved.

FIG. 4 is a schematic view of a display panel of the present application. Referring to the embodiment shown by FIG. 4, in this embodiment, preferably, the first substrate is, for example, an array substrate 30; the second substrate is, for example, a color filter substrate 40;

the display panel 100 further includes a front polarizer 10 disposed on the outer side of the array substrate 30 and a rear polarizer 20 disposed on the outer side of the color filter substrate 40;

The sealing layer 60 includes a sealing adhesive layer 62 disposed on the inner side, a light shielding layer 61 disposed at the middle, and a protective adhesive layer 63 disposed on the outer side of the light shielding layer 61 and configured to seal the edges of the front polarizer 10 and the rear polarizer 20. In this solution, since a protective adhesive layer is disposed on the periphery of the sealing layer, the dust resistance, water resistance, electromagnetic wave resistance and impact resistance and the like of the substrate are improved; moreover, because the protective adhesive layer is adopted for sealing from the edges of the front polarizer and the rear polarizer, the front polarizer and the rear polarizer are also protected from impact and the like, the problem of poor upwarp of the polarizer can be solved, and the yield of the product is improved; the three-layer structure of combination of the light shielding layer, the sealing adhesive layer and the protective adhesive layer has better light shielding, sealing and cushioning effects than a single-layer composite adhesive; moreover, the requirements a single layer intangible material are lowered, and the technical requirements are lowered while the yield of the product is improved.

Preferably, in this embodiment, the protective adhesive layer 63 includes an electromagnetic wave protective adhesive layer, a water vapor protective adhesive layer or an electromagnetic water vapor protective adhesive layer. In this solution, the electromagnetic wave protective adhesive layer, the water vapor protective adhesive layer or the electromagnetic water vapor protective adhesive layer can be selected according to different product positioning and different requirements, thereby achieving effects such as water vapor protection or static electricity protection, and improving product quality.

Preferably, in this embodiment, referring to FIG. 3, the light shielding layer 61 adopts light shielding ink; the sealing adhesive layer 62 adopts a hot melt adhesive or a photocurable adhesive;

the first substrate is, for example, an array substrate 30; the second substrate is, for example, a color filter substrate 40;

the display panel 100 further includes a front polarizer 10 disposed on the outer side of the array substrate 30 and a rear polarizer 20 disposed on the outer side of the color filter substrate 40;

the sealing layer 60 includes a light shielding layer 61 disposed on the inner side, a sealing adhesive layer 62 disposed at the middle, and a protective adhesive layer 63 disposed on the outer side of the sealing adhesive layer 62 and configured to seal the edges of the front polarizer 10 and the rear polarizer 20;

the protective adhesive layer 63 includes an electromagnetic wave protective adhesive, a water vapor protective adhesive or an electromagnetic water vapor protective adhesive. The three-layer structure of combination of the light shielding layer, the sealing adhesive layer and the protective adhesive layer has better light shielding, sealing and cushioning effects than a single-layer composite adhesive; moreover, the requirements a single layer intangible material are lowered, and the technical requirements are lowered while the yield of the product is improved.

Preferably, in this embodiment, referring to FIG. 3, the light shielding layer 61 adopts a black sealant or a black adhesive tape; the sealing adhesive layer 62 adopts a hot melt adhesive or a photocurable adhesive;

the first substrate includes an array substrate 30; the second substrate includes a color filter substrate 40;

the display panel 100 further includes a front polarizer 10 disposed on the outer side of the array substrate 30 and a rear polarizer 20 disposed on the outer side of the color filter substrate 40;

the sealing layer 60 also includes a protective adhesive layer 63 disposed on the outer side of the sealing adhesive layer 62 and configured to seal the edges of the front polarizer 10 and the rear polarizer 20;

the protective adhesive layer 63 adopts an electromagnetic wave protective adhesive, a water vapor protective adhesive or an electromagnetic water vapor protective adhesive. In this solution, the black adhesive tape or the black sealant is retained, so that original related apparatuses can be retained to prevent waste, and the sealing adhesive layer and the protective adhesive layer are disposed on the outer side of the black adhesive tape or the black sealant, thereby improving the light shielding, viscosity, durability, impact resistance, water vapor resistance, anti-static performance and the like of the product in this solution can be improved; moreover, the physical property requirements for the black adhesive tape or black sealant are also relatively reduced, i.e., the original unqualified black adhesive tape or black sealant already can be used partially to reduce waste and improve product yield.

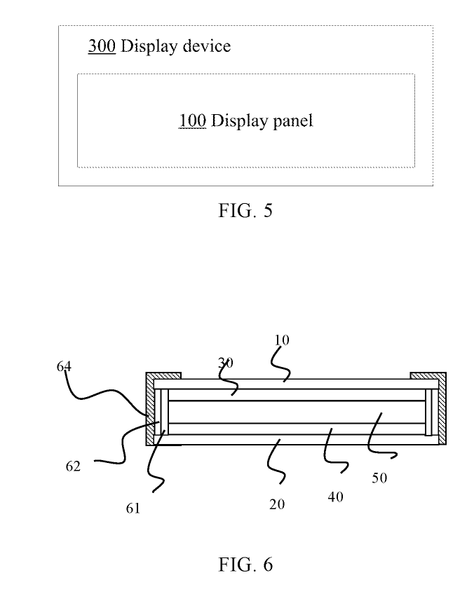

FIG. 5 is a schematic view of a display device of the present application. Referring to the embodiment shown by FIG. 3, the display device 300 includes any disclosed display panel 100 of the present application.

The present application has the beneficial effects that a frameless display panel, such as a frameless liquid crystal panel, mainly includes a substrate and a backlight module, where the substrate mainly includes an array substrate, a color filter substrate, and a sealing layer for sealing the array substrate and the color filter substrate from the two ends. An existing sealing layer is used for sealing often by the adoption of the black adhesive tape, but after long-term use, the black adhesive tape is prone to viscosity weakening and falling off, which will lead to the problems of light leakage and low product yield. In the present application, since the light shielding layer and the sealing adhesive layer are used and functions of each layer are clear, it is not necessary to consider the shading rate and the sealing property as in the black adhesive tape, so that the specificity can be achieved, thereby achieving better shading and sealing performance, solving the problems of falling off and light leakage, and enhancing the product yield.

In fact, the display panel of the present application more specifically includes an array substrate on a first side of the substrate, a color filter substrate on a second side, and a liquid crystal layer sandwiched between the array substrate and the color filter substrate;

a thin film transistor layer and a first polarizer are also sequentially disposed between the array substrate and the liquid crystal layer;

a color filter layer and a second polarizer are also sequentially disposed between the color filter substrate and the liquid crystal layer;

in addition, a front polarizer and a rear polarizer are disposed on the outer sides of the array substrate and the color filter substrate respectively. The sealing layer of the present application is disposed at both ends of the substrate to seal all components between the front polarizer and the rear polarizer.

As shown in FIG. 6, the display panel in FIG. 6 includes:

a first substrate 30, which includes an active switch (e.g., a TFT) array and a surrounding metal circuit, where the surrounding metal circuit is disposed around the active switch array;

a second substrate 40 disposed opposite to the first substrate;

a liquid crystal layer 50 formed between the first substrate and the second substrate;

a front polarizer 10 disposed on the outer side of the first substrate;

a rear polarizer 20 disposed on the outer side of a color filter substrate;

sealing layers 61 and 62 formed around the display panel and configured to seal the liquid crystal layer 50 between the first substrate 30 and the second substrate 40; and

a light shielding protective adhesive layer 62 formed on the sealing layer, where the light shielding protective adhesive layer extends from the edge of the rear polarizer 20 to the outer side of the front polarizer 10 and may shield the surrounding metal circuit. The light shielding protective adhesive layer 62 can have a light shielding effect to avoid reflection of the surrounding metal circuit.

In some embodiments, the light shielding protective adhesive layer 62 may include light shielding ink to shield the light reflected by the surrounding metal circuit.

The preferred embodiments of the present application have been described in detail above. It should be understood that many modifications and variations can be made by a person skilled in the art according to the conception of the present application without departing from the scope of the present application. Therefore, any technical solution that can be obtained by a person skilled in the art according to the conception of the present application based on the prior art by logic analysis, reasoning or limited experimentation should be within the scope of protection determined by the claims.

What is claimed is:

1. A display panel, comprising:
a first substrate, which comprises an active switch array and a surrounding metal circuit, wherein the surrounding metal circuit is disposed around the active switch array;
a second substrate disposed opposite to the first substrate;
a liquid crystal layer formed between the first substrate and the second substrate;
a front polarizer disposed on the outer side of the first substrate;
a rear polarizer disposed on the outer side of the second substrate;
sealing layers formed around the display panel and configured to seal the liquid crystal layer between the first substrate and the second substrate; and
a light shielding protective adhesive layer formed on the sealing layer, wherein the light shielding protective adhesive layer extends from the edge of the rear polarizer to the outer side of the front polarizer and shields the surrounding metal circuit.

2. The display panel according to claim 1, wherein the sealing layer comprises a light shielding layer which adopts light shielding ink.

3. The display panel according to claim 1, wherein the sealing layer comprises a light shielding layer which adopts a black sealant or a black adhesive tape.

4. The display panel according to claim 1, wherein the sealing layer comprises a sealing adhesive layer which adopts a hot melt adhesive.

5. The display panel according to claim 1, wherein the sealing layer comprises a sealing adhesive layer which adopts a photocurable adhesive.

6. The display panel according to claim 1, wherein the light shielding protective adhesive layer comprises an electromagnetic wave protective adhesive layer, a water vapor protective adhesive layer or an electromagnetic water vapor protective adhesive layer.

7. The display panel according to claim 1, wherein the sealing layer comprises a light shielding layer and a sealing adhesive layer, the light shielding layer adopts light shielding ink, and the sealing adhesive layer adopts a hot melt adhesive or a photocurable adhesive.

8. The display panel according to claim 1, wherein the sealing layer comprises a light shielding layer and a sealing adhesive layer, the light shielding layer adopts light shielding ink, and the sealing adhesive layer adopts a hot melt adhesive or a photocurable adhesive.

9. The display panel according to claim 4, wherein the hot melt adhesive is polyurethane reactive hot melt adhesive.

10. The display panel according to claim 5, wherein the hot melt adhesive is polyurethane reactive hot melt adhesive.

11. A display panel, comprising:
a first substrate, which comprises an active switch array and a surrounding metal circuit, wherein the surrounding metal circuit is disposed around the active switch array;
a second substrate disposed opposite to the first substrate;
a liquid crystal layer formed between the first substrate and the second substrate;
a front polarizer disposed on the outer side of the first substrate;
a rear polarizer disposed on the outer side of the second substrate;
sealing layers formed around the display panel and configured to seal the liquid crystal layer between the first substrate and the second substrate; and
a light shielding protective adhesive layer formed on the sealing layer, wherein the light shielding protective adhesive layer extends from the edge of the rear polarizer to the outer side of the front polarizer and shields the surrounding metal circuit;
wherein the sealing layer comprises a light shielding layer and a sealing adhesive layer, wherein the light shielding layer adopts light shielding ink, and the sealing adhesive layer adopts a hot melt adhesive;
wherein the light shielding protective adhesive layer comprises an electromagnetic wave protective adhesive layer, a water vapor protective adhesive layer or an electromagnetic water vapor protective adhesive layer.

12. A display device, comprising a display panel, wherein the display panel comprises:
a first substrate, which comprises an active switch array and a surrounding metal circuit, wherein the surrounding metal circuit is disposed around the active switch array;
a second substrate disposed opposite to the first substrate;
a liquid crystal layer formed between the first substrate and the second substrate;
a front polarizer disposed on the outer side of the first substrate;
a rear polarizer disposed on the outer side of the second substrate;
sealing layers formed around the display panel and configured to seal the liquid crystal layer between the first substrate and the second substrate; and
a light shielding protective adhesive layer formed on the sealing layer, wherein the light shielding protective adhesive layer extends from the edge of the rear polarizer to the outer side of the front polarizer and shields the surrounding metal circuit.

13. The display device according to claim 12, wherein the sealing layer comprises a light shielding layer and a sealing adhesive layer, the light shielding layer adopts light shielding ink, and the sealing adhesive layer adopts a hot melt adhesive or a photocurable adhesive.
the light shielding protective adhesive layer comprises an electromagnetic wave protective adhesive layer, a water vapor protective adhesive layer or an electromagnetic water vapor protective adhesive layer.

14. The display device according to claim 12, wherein the sealing layer comprises a light shielding layer and a sealing adhesive layer, the light shielding layer adopts light shielding ink, and the sealing adhesive layer adopts a hot melt adhesive or a photocurable adhesive;
the light shielding protective adhesive layer comprises an electromagnetic wave protective adhesive layer, a water vapor protective adhesive layer or an electromagnetic water vapor protective adhesive layer.

15. The display device according to claim 12, wherein the sealing layer comprises a sealing adhesive layer and a protective adhesive layer, the sealing adhesive layer is disposed on the outer side of the sealing adhesive layer, and the protective adhesive layer seals the edges of the front polarizer and the rear polarizer.

16. The display device according to claim 13, wherein the hot melt adhesive is polyurethane reactive hot melt adhesive, and the photocurable adhesive is UV-curable adhesive.

17. The display device according to claim 14, wherein the hot melt adhesive is polyurethane reactive hot melt adhesive, and the photocurable adhesive is UV-curable adhesive.

18. The display device according to claim 12, wherein the first substrate is an array substrate, and the second substrate is a color filter substrate;
a thin film transistor layer and a first polarizer are also sequentially disposed between the first substrate and the liquid crystal layer;
a color filter layer and a second polarizer are also sequentially disposed between the second substrate and the liquid crystal layer.
